(19) United States
(12) Patent Application Publication
(10) Pub. No.: US 2025/0251976 A1
(43) Pub. Date: Aug. 7, 2025

(54) RESOURCE ALLOCATION METHOD AND SYSTEM

(71) Applicants: HAINAN INSTITUTE OF ZHEJIANG UNIVERSITY, Sanya City (CN); ZHEJIANG UNIVERSITY, Hangzhou City (CN)

(72) Inventors: Hailiang ZHAO, Hangzhou City (CN); Shuiguang DENG, Hangzhou City (CN); Yirong ZHANG, Hangzhou City (CN); Jianwei YIN, Hangzhou City (CN)

(21) Appl. No.: 19/013,629

(22) Filed: Jan. 8, 2025

Related U.S. Application Data
(63) Continuation of application No. PCT/CN2024/083219, filed on Mar. 22, 2024.

(30) Foreign Application Priority Data
Feb. 4, 2024 (CN) 202410156847.2

(51) Int. Cl. G06F 9/50

(52) U.S. Cl. CPC G06F 9/5005

(57) ABSTRACT

A resource allocation method for allocating resources to respective applications based on user request information in a microservice system, which includes: acquiring a target optimization model that includes a plurality of sub-optimization models in one-to-one correspondence to resources; an optimization goal of each of the plurality of sub-optimization models being to minimize a sum of average response time of all of applications on a corresponding resource; variables of the sub-optimization model including a decision variable and an environmental variable; acquiring environmental parameters currently corresponding to the microservice system; and solving respective sub-optimization models in parallel based on the environmental parameters according to ADMM to obtain optimal solutions corresponding to respective decision variables and generate a corresponding resource allocation strategy. By solving the respective sub-optimization models in parallel, an optimal allocation result corresponding to respective resources can be obtained and the average response time of the respective applications are optimized.

### CROSS-REFERENCE TO RELATED APPLICATIONS

This application is a Continuation of co-pending Application No. PCT/CN2024/083219 filed on Mar. 22, 2024, for which priority is claimed under 35 U.S.C. § 120; and this application claims priority of application Ser. No. 20/241,0156847.2 filed in China on Feb. 4, 2024 under 35 U.S.C. § 119; the entire contents of all of which are hereby incorporated by reference.

### TECHNICAL FIELD

The disclosure relates to the field of resource allocation, in particular to resource allocation technology for a large microservice ecosystem.

### BACKGROUND ART

In recent years, a microservice system has been applied more and more extensively. The microservice system, also known as microservice architecture, is an architecture scheme for building applications, which decomposes complex functions of the system into discrete services, which each run in independent processes and communicate with each other through well-defined interfaces (such as REST), thus reducing coupling of the system and improving stability and flexibility of the system. Highly distributed and dynamic characteristics of the large microservice system make a number of service nodes rapidly increase, dependency between services become increasingly complex, and there are many resources involved, such as CPU, GPU, memories, etc., and it becomes an important issue to allocate resources reasonably to ensure availability, stability and efficiency of the microservice ecosystem, which requires effective resource allocation algorithms to achieve.

Existing resource allocation algorithms mainly serve to schedule according to weights, priorities or in other ways, and thus it is difficult to ensure that average completion time of each application is minimized.

### SUMMARY

In view of shortcomings in related art, the disclosure provides resource allocation technology for optimizing average response time of each application in a large microservice ecosystem.

In order to solve the above technical problems, the present disclosure provides following technical solutions.

A resource allocation method for allocating resources to respective applications based on user request information in a microservice system includes:
acquiring a target optimization model, the target optimization model including a plurality of sub-optimization models in one-to-one correspondence to resources;
   an optimization goal of each of the plurality of sub-optimization models being to minimize a sum of average response time of all of applications on a corresponding resource;
   variables of the sub-optimization model including a decision variable and an environmental variable;
   the decision variable including total allocation and sub-allocation of the corresponding resource, the total allocation referring to allocation of the corresponding resource in the microservice system, and the sub-allocation referring to allocation of the corresponding resource in the respective applications; and
   the environment variable including a set of user requests corresponding to the respective applications and internal communication overhead;
acquiring environmental parameters currently corresponding to the microservice system;
solving respective sub-optimization models in parallel based on the environmental parameters according to Alternating Direction Method of Multiplier to obtain optimal solutions corresponding to respective decision variables and generate a corresponding resource allocation strategy.

As a possible implementation, the target optimization model is constructed by:
constructing an original calculation function, the original calculation function being configured to calculate average response time of a target application based on the environmental parameters;
constructing a diversified constraint condition based on a group norm to obtain a first constraint, the diversified constraint condition indicating that for each type of resource, corresponding resources in respective applications are less than or equal to an upper limit threshold of the resource;
taking a matrix vector multiplication form of sub-allocation corresponding to the target application as a second constraint;
constructing a problem of minimizing the sum of average response time of all of the applications based on the original calculation function, the first constraint and the second constraint to obtain a target optimization problem; and
dividing the target optimization problem into sub-problems in one-to-one correspondence to the resources, and taking an augmented Lagrangian function corresponding to respective sub-problems as a corresponding sub-optimization model.

As a possible implementation:
the original calculation function is:

$$MRT ( {λ}_{n} , {Γ}_{n} , {y}^{{G}_{n}} ) = \frac{{L}_{n}}{{λ}_{n}} + \frac{1}{{f}_{n} ( {Γ}_{n} , {y}^{{G}_{n}} ) - {O}_{n} ( {Γ}_{n} , {n}_{} )}$$

in which:
MRT (λₙ, Γₙ, y^{G}^{ₙ}) is average response time corresponding to a n-th application;

$$\frac{{L}_{n}}{{λ}_{n}}$$

is average waiting time of a queue;

$$\frac{1}{{f}_{n} ( {Γ}_{n} , {y}^{{G}_{n}} ) - {O}_{n} ( {Γ}_{n} , {n}_{} )}$$

is average service time;
λₙ is an average rate at which an user request arrives at the n-th application;
Lₙ is an average number of user requests in a queue corresponding to the n-th application;
Γₙ is a set of user requests corresponding to the n-th application;
y^{G}^{ₙ} represents sub-allocation of respective resources in the n-th application;
fₙ(Γₙ, y^{G}^{ₙ}) represents an average processing speed of the n-th application for a set Γₙ of arrived user requests and a resource with given y^{G}^{ₙ};
Oₙ(Γₙ, [symbol] ) represents internal communication overhead of the n-th application.

As a possible implementation:

The target optimization problem is as follows:

$$\text{:} {min}_{y} {\sum }_{n ∈ [ N ]} MRT ( {λ}_{n} , {Γ}_{n} , {y}^{{G}_{n}} )$$

$$s . t . \{ \begin{matrix}{‖ {y}_{k} ‖}_{( ∞ , 1 )}^{[ N ]} \leq {μ}_{k} , ∀ k \\ {y}_{k}^{N} = {S}_{n} {y}_{k} , ∀ k , n\end{matrix}$$

$${{{‖ {y}_{k} ‖}_{( ∞ , 1 )}^{[ N ]} : \text{=} {‖ [ \vert \vert {y}_{k}^{{G}_{1}} ‖}_{1} , … , {‖ {y}_{k}^{{G}_{N}} ‖}_{1} ]}^{T} ‖}_{∞}$$

$${[ {S}_{n} ]}_{mm} = \{ \begin{matrix}1 , & m ∈ {V}_{n} \\ 0 , & otherwise\end{matrix}$$

in which:
yₖ is total distribution of a k-th type of resource;
yₖ^{G}^{_{N}} is sub-allocation of a k-th type of resource in the n-th application, and yₖⁿ is short for yₖ^{G}^{_{N}};
Sₙ is a diagonal matrix;
μₖ is an upper threshold corresponding to the k-th type of resource;
[symbol] is a set of microservices in the n-th application; and
m is a m-th microservice in the n-th application.

As a possible implementation:

A sub-problem corresponding to the k-th type of resource is as follows:

$$( k ) \text{:} {min}_{{y}_{k}} - {\sum }_{n ∈ [ N ]} ( {R}_{k} ( {y}_{k}^{N} ) + h ( {y}_{k}^{N} ) )$$

$$s . t . {y}_{k}^{n} = {S}_{n} {y}_{k} , ∀ n .$$

$${R}_{k} ( {y}_{k}^{n} ) := \frac{{α}_{k}}{\vert Γ \vert} {\sum }_{r ∈ {Γ}_{n}} {f}_{n , k} ( {y}_{k}^{n} ) - \frac{1}{K {α}_{k}} {O}_{n} ( {Γ}_{n} , ) ,$$

$$h ( {y}_{k}^{n} ) = \{ {‖ {y}_{k}^{n} ‖}_{1} \leq {μ}_{k} \} , ∀ k , n$$

in which:
a fₙₖ function is a processing speed of the n-th application for a user request r after being allocated with the k-th type of resource;
αₖ is a contribution weight of the processing speed corresponding to the k-th type of resource to a final service rate; and
K is a total number of resource types.

As a possible implementation:
the sub-optimization model is an augmented Lagrangian function in a dual form.

The sub-optimization model corresponding to the k-th type of resource is expressed as follows:

$$L ( {y}_{k} , {\{ {y}_{k}^{n} \}}_{n} , {\{ {u}_{n} \}}_{n} ) = - {\sum }_{n} ( {R}_{k} ( {y}_{k}^{n} ) + h ( {y}_{k}^{n} ) ) + \frac{η}{2} {\sum }_{n} {‖ {S}_{n} {y}_{k} - {y}_{k}^{n} + {u}_{n} ‖}^{2}$$

$${R}_{k} ( {y}_{k}^{n} ) := \frac{{α}_{k}}{\vert Γ \vert} {\sum }_{r ∈ {Γ}_{n}} {f}_{n , k} ( {y}_{k}^{n} ) - \frac{1}{K {α}_{k}} {O}_{n} ( {Γ}_{n} , ) ,$$

$$h ( {y}_{k}^{n} ) = \{ {‖ {y}_{k}^{n} ‖}_{1} \leq {μ}_{k} \} , ∀ k , n$$

$${[ {S}_{n} ]}_{mm} = \{ \begin{matrix}1 , & m ∈ {V}_{n} \\ 0 , & otherwise\end{matrix}$$

in which:
yₖ is total distribution of a k-th type of resource;
yₖⁿ is sub-allocation of a k-th type of resource in the n-th application;
{uₙ}ₙ is a dual variable;
η is a penalty coefficient;
αₖ is a contribution weight of the processing speed corresponding to the k-th type of resource to a final service rate;
Γₙ is a set of user requests corresponding to the n-th application;
a fₙₖ function is a processing speed of the n-th application for a user request r after being allocated with the k-th type of resource;
K is a total number of resource types;
Oₙ(Γₙ, [symbol] ) represents internal communication overhead of the n-th application;
Sₙ is a diagonal matrix;
μₖ is an upper threshold corresponding to the k-th type of resource;
[symbol] is a set of microservices in the n-th application; and
m is a m-th microservice in the n-th application.

A resource allocation system for allocating resources to respective applications based on user request information in a microservice system includes:
a model acquisition module configured to acquire a target optimization model, the target optimization model including a plurality of sub-optimization models in one-to-one correspondence to resources;
   an optimization goal of each of the plurality of sub-optimization models being to minimize a sum of average response time of all of applications on a corresponding resource;
   variables of the sub-optimization model including a decision variable and an environmental variable;
   the decision variable including total allocation and sub-allocation of the corresponding resource, the total allocation referring to allocation of the corresponding resource in the microservice system, and the sub-allocation referring to allocation of the corresponding resource in the respective applications; and
   the environment variable including a set of user requests corresponding to the respective applications and internal communication overhead;
a data acquisition module configured to acquire environmental parameters currently corresponding to the microservice system; and
an optimization module configured to solve respective sub-optimization models in parallel based on the environmental parameters according to Alternating Direction Method of Multiplier to obtain optimal solutions corresponding to respective decision variables and generate a corresponding resource allocation strategy.

As a possible implementation, the model acquisition module includes a model construction module configured to:
construct an original calculation function, the original calculation function being configured to calculate average response time of a target application based on the environmental parameters;
construct a diversified constraint condition based on a group norm to obtain a first constraint, the diversified constraint condition indicating that for each type of resource, corresponding resources in respective applications are less than or equal to an upper limit threshold of the resource;
take a matrix vector multiplication form of sub-allocation corresponding to the target application as a second constraint;
construct a problem of minimizing the sum of average response time of all of the applications based on the original calculation function, the first constraint and the second constraint to obtain a target optimization problem; and
divide the target optimization problem into sub-problems in one-to-one correspondence to the resources, and take an augmented Lagrangian function corresponding to respective sub-problems as a corresponding sub-optimization model.

The disclosure further provides a computer-readable storage medium having a computer program stored thereon which, when executed by a processor, implements steps of any one of the above resource allocation methods.

The disclosure further provides an electronic device, which includes a memory, a processor and a computer program stored on the memory and operable on the processor, and the processor implements the resource allocation method described in any one of above implementations when executing the program.

With the above technical scheme, the disclosure presents obvious technical effects as follows.

In the disclosure, by solving the respective sub-optimization models in parallel, an optimal allocation result corresponding to respective resources can be obtained and the average response time of the respective applications are optimized.

In the disclosure, the group norm is adopted to constrain resource allocation diversification, and finally an optimal solution of the response time under the constraint condition is obtained based on the ADMM algorithm, so that for a complex and dynamic large microservice system, the average response time of the microservice can be minimized on a basis of ensuring certain resource allocation diversification, and resource allocation effect of the large microservice system is effectively improved.

### BRIEF DESCRIPTION OF THE DRAWINGS

In order to explain the embodiments of the present disclosure or the technical scheme in the prior art more clearly, the drawings required in the description of the embodiments or the prior art will be briefly introduced below; obviously, the drawings in the following description are only some embodiments of the present disclosure, and other drawings can be obtained according to these drawings by those of ordinary skilled in the art without paying creative labor.

FIG. 1 is a schematic view of a call graph of an application;

FIG. 2 is a schematic flowchart of a resource allocation method according to the present disclosure; and

FIG. 3 is a schematic flowchart of a construction method of a target optimization model in Embodiment 1.

### DETAILED DESCRIPTION

The present disclosure will be further described in detail with reference to the following examples which present explanation the present disclosure and the present disclosure is not limited to the following examples.

### Description:

### 1.1) Microservice and Application:

Resource allocation is performed for a large computing cluster composed of M microservices and N applications.

Each application consists of a plurality of interdependent microservices, and calling of microservices in each application can be abstracted into a call graph, [symbol] :=( [symbol] , [symbol] ) is used to represent a call graph of a n-th application, in which [symbol] ⊆[M] represents a set of microservices corresponding to the n-th application, and each directed edge (m₁, m₂)∈ [symbol] represents a calling relationship between an upstream microservice m₁ and a downstream microservice m₂.

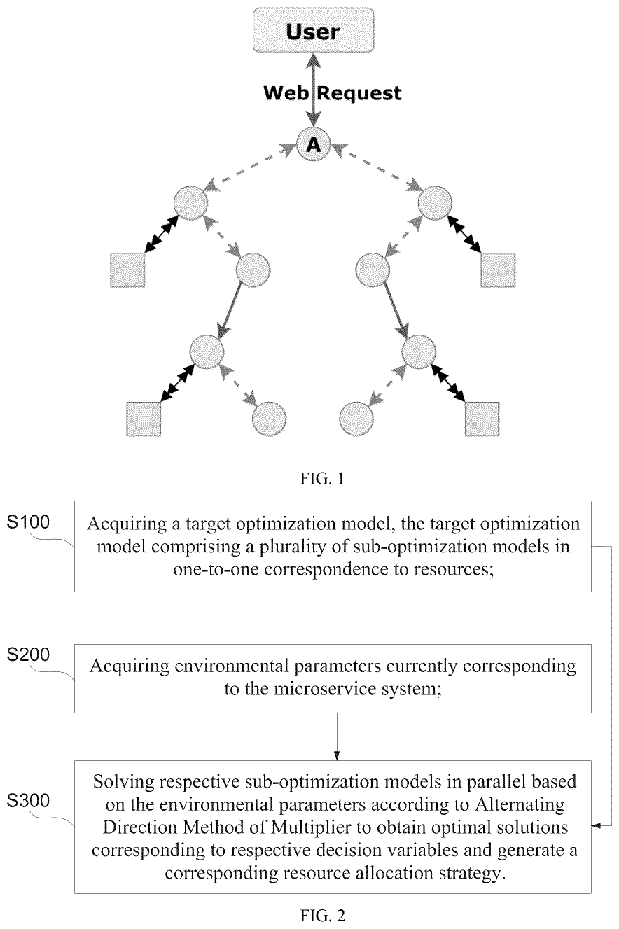

A call graph of an application based on microservices is topologically similar to a tree. As shown in FIG. 1, a set [symbol] of microservices corresponding to each application consists of a portal microservice and several internal stateful or stateless microservices. A user request sent through http is firstly captured by the portal microservice, and then other microservices are called to handle the user request.

### 1.2) Resource Allocation Representation:

There are K types of resources in the large computing cluster that need to be allocated in microservices, such as CPU, memories, GPU, etc.

In this specification, yₖ=[yₖ₁, . . . , y_{kM}]^{T}∈R^{M} s used to indicate total allocation of the k-th resource, and the total allocation refers to allocation of the corresponding resource in the microservice system, that is, allocation of the k-th resource in all of the microservices.

In this specification, yₖ∈R^{M} is used to indicate allocation of the k-th type of resource in the n-th application, which is abbreviated as yₖⁿ herein, and yₖ^{G}^{_{N}} is expressed as follows:

$${[ {y}_{k}^{{G}_{n}} ]}_{m} = \{ \begin{matrix}1 , & m ∈ {V}_{n} \\ 0 , & otherwise\end{matrix} .$$

In this specification, y is used to indicate allocation of respective resources in the microservice system, and y^{G}^{ₙ} is used to indicate allocation of respective resources in the n-th application, and their corresponding expressions are as follows:

y:=[y₁^{T}, . . . , y_{K}^{T}]^{T}∈R^{MK}

y^{G}^{ₙ}:=[(y₁^{G}^{ₙ})^{T}, . . . , (y_{K}^{G}^{ₙ})^{T}]^{T}

1.3) Modeling of response time of application:

An object of the resource allocation method according to the disclosure is to minimize a sum of average response time of the respective applications. Firstly, average response time of each application is modeled, and an application based on microservices is modeled as a queue. A calculation formula of the average response time is as follows:

$$MRT ( {λ}_{n} , {Γ}_{n} , {y}^{{G}_{n}} ) = \frac{{L}_{n}}{{λ}_{n}} + \frac{1}{{f}_{n} ( {Γ}_{n} , {y}^{{G}_{n}} ) - {O}_{n} ( {Γ}_{n} , {n}_{} )}$$

It can be seen from the above that the average response time can be divided into two parts:
average waiting time of the queue

$$\frac{{L}_{n}}{{λ}_{n}} ,$$

in which λₙ is an average rate at which an user request arrives at the n-th application and Lₙ is an average number of user requests in a queue corresponding to the n-th application; and
average service time

$$\frac{1}{{f}_{n} ( {Γ}_{n} , {y}^{{G}_{n}} ) - {O}_{n} ( {Γ}_{n} , )} ,$$

which is calculated with an average service rate. The average service rate consists of two parts, in which fₙ(Γₙ, y^{G}^{ₙ}) represents an average processing speed of the n-th application for a set Γₙ of arrived user requests and a resource with given y^{G}^{ₙ}; and Oₙ(Γₙ, Gₙ) represents the internal communication overhead.

fₙ(Γₙ, y^{G}^{ₙ}) is expressed as follows:

$${f}_{n} ( {Γ}_{n} , {y}^{{G}_{n}} ) : = \frac{1}{\vert {Γ}_{n} \vert} {\sum }_{r ∈ {Γ}_{n}} {\sum }_{k ∈ [ K ]} {α}_{k} {f}_{nk} ( {y}_{k}^{{G}_{n} ( r )} )$$

in which:
a fₙₖ function is a processing speed of the n-th application for a user request r after being allocated with the k-th type of resource;
αₖ represents a contribution weight of a processing speed allocated with the k-th resource to a final service rate; and
Gₙ(r) indicates that the call graph is related to an application request r, because internal call of the microservices may vary with a state of the user request r. Analysis of Alibaba Trace shows that nearly 60% of applications use two calling topologies to implement, and more than 10% of applications have nine calling topologies.

Considering that the resource allocation is focused, because a topological structure of the call graph has no influence on yₖ^{G}^{ₙ}, for sake of simplification, r is removed from Gₙ(r) in the following.

fₙₖ(yₖ^{G}^{ₙ}) is a zero-start concave function of a k-th resource allocation yₖ^{G}^{ₙ}, and marginal effect of acceleration may decrease with increase of allocated resources. In an actual microservice based system, the average processing speed is usually achieved by expanding container instances when resources are increased.

Internal communication overhead of microservices is proportional to an internal call scale, that is | [symbol] |. A number of the allocated resources may not directly affect the communication overhead, because when a microservice has multiple instances, calling of the microservice from an upstream microservice may be routed to one of the instances according to a certain load balancing strategy.

Therefore, the internal communication overhead Oₙ(Γₙ, [symbol] ) is expressed as:

Oₙ(Γₙ, [symbol] ):=βₙ| [symbol] (r)|

in which: βₙ is a preset overhead coefficient, and [symbol] (r) is a set of calling relationships corresponding to the user request r.

Embodiment 1, a resource allocation method for allocating resources to respective applications based on user request information in a microservice system, as shown in FIG. 2, includes steps S100 to S300.

At S100, a target optimization model is acquired, and the target optimization model includes a plurality of sub-optimization models in one-to-one correspondence to resources.

An optimization goal of each of the plurality of sub-optimization models is to minimize a sum of average response time of all of applications on a corresponding resource.

Variables of the sub-optimization model includes a decision variable and an environmental variable.

The decision variable includes total allocation and sub-allocation of the corresponding resource.

The total allocation refers to allocation of the corresponding resource in the microservice system.

The sub-allocation refers to allocation of the corresponding resource in the respective applications.

The environment variable includes a set of user requests corresponding to the respective applications and internal communication overhead.

At S200, environmental parameters currently corresponding to the microservice system are acquired.

At S300, respective sub-optimization models in parallel are solved based on the environmental parameters according to Alternating Direction Method of Multiplier to obtain optimal solutions corresponding to respective decision variables and generate a corresponding resource allocation strategy.

In this embodiment, by solving the respective sub-optimization models in parallel, an optimal allocation result corresponding to respective resources can be obtained and the average response time of the respective applications are optimized.

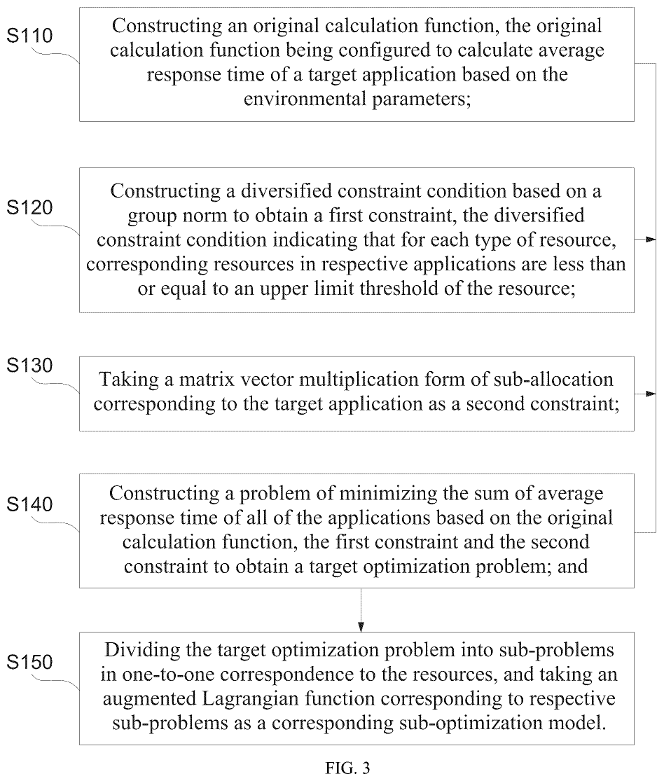

Referring to FIG. 3, the target optimization model described in step S100 is constructed by following steps S110 to S150.

At S110, an original calculation function is constructed.

The original calculation function is configured to calculate average response time of a target application based on the environmental parameters.

In this embodiment, the MRT(λₙ, Γₙ, y^{G}^{ₙ}) function described in 1.3 above is taken as the original calculation function, which will not be described here again.

At S120, a diversified constraint condition is constructed based on a group norm to obtain a first constraint.

The diversified constraint condition indicates that for each type of resource, corresponding resources in respective applications are less than or equal to an upper limit threshold of the resource.

For a given application set [N], a group norm L_{(∞,1)} on yₖ is introduced, which is as follows:

∥yₖ∥_{(∞,1)}^{[N]}:=∥[∥yₖ^{G}^{₁}∥₁, . . . , ∥yₖ^{G}^{_{N}}∥₁]^{T}∥_{∞}

the first constraint is:

∥yₖ∥_{(∞,1)}^{[N]}≤μₖ, ∀k

in which μₖ is an upper threshold corresponding to the k-th type of resource;

With design of the first constraint, each application can flexibly add the k-th type of resources to μₖ without changing a norm ball;

With design of μₖ, not only structural diversity can be realized to ensure certain resource allocation diversification, but also limitations of resource capacity can be met with no need to set additional constraints on the resource capacity.

At S120, a matrix vector multiplication form of sub-allocation corresponding to the target application is taken as a second constraint.

The second constraint is:

yₖⁿ=Sₙyₖ, ∀k,n.

in which Sₙ is a diagonal matrix with a following form:

$${[ {S}_{n} ]}_{mm} = \{ \begin{matrix}1 , & m ∈ {V}_{n} \\ 0 , & otherwise\end{matrix}$$

In the above formula:
[symbol] is a set of microservices in the n-th application; and
m is a m-th microservice in the n-th application.

The second constraint is the matrix-vector multiplication form of resource allocation, with no new constraint scenario added.

At S130, a problem of minimizing the sum of average response time of all of the applications is constructed based on the original calculation function, the first constraint and the second constraint to obtain a target optimization problem.

The target optimization problem is as follows:

$$\text{:} {min}_{y} {\sum }_{n ∈ [ N ]} MRT ( {λ}_{n} , {Γ}_{n} , {y}^{{G}_{n}} )$$

$$s . t . \{ \begin{matrix}{‖ {y}_{k} ‖}_{( ∞ , 1 )}^{[ N ]} \leq {μ}_{k} , ∀ k \\ {y}_{k}^{N} = {S}_{n} {y}_{k} , ∀ k , n\end{matrix}$$

At S140, the target optimization problem is divided into sub-problems in one-to-one correspondence to the resources, and an augmented Lagrangian function corresponding to respective sub-problems is taken as a corresponding sub-optimization model.

At S141, a sub-problem corresponding to the k-th type of resource is as follows:

$$\begin{matrix}( k ) : {min}_{{y}_{k}} - {\sum }_{n ∈ [ N ]} ( {R}_{k} ( {y}_{k}^{n} ) + h ( {y}_{k}^{n} ) ) \\ s . t . {y}_{k}^{n} = {S}_{n} {y}_{k} , ∀ n . \\ {R}_{k} ( {y}_{k}^{n} ) := \frac{{α}_{k}}{\vert {Γ}_{n} \vert} {\sum }_{r ∈ {Γ}_{n}} {f}_{nk} ( {y}_{k}^{n} ) - \frac{1}{K {α}_{k}} {O}_{n} ( {Γ}_{n} , ) \\ h ( {y}_{k}^{n} ) = 𝕝 \{ {‖ {y}_{k}^{n} ‖}_{1} \leq {μ}_{k} \} , ∀ k , n\end{matrix} ,$$

in which:
a fₙₖ function is a processing speed of the n-th application for a user request r after being allocated with the k-th type of resource;
αₖ is a contribution weight of the processing speed corresponding to the k-th type of resource to a final service rate; and
K is a total number of resource types.

A h(yₖⁿ) function is an exponential function, and when a predicate p is true, a value of 1{p} is 1.

At S142, the sub-problem is converted into an augmented Lagrangian function in a dual form to obtain the corresponding sub-optimization model.

In this embodiment, the sub-optimization model corresponding to the k-th type of resource is expressed as follows:

$$L ( {y}_{k} , {\{ {y}_{k}^{n} \}}_{n} , {\{ {u}_{n} \}}_{n} ) = - {\sum }_{n} ( {R}_{k} ( {y}_{k}^{n} ) ) + \frac{η}{2} {\sum }_{n} {‖ {S}_{n} {y}_{k} - {y}_{k}^{n} + {u}_{n} ‖}^{2}$$

in which:
{uₙ}ₙ is a dual variable; and
η is a penalty coefficient.

With the total allocation yₖ of the k-th type of resource in the sub-optimization model above and the sub-allocation {yₖⁿ}ₙ of the k-th type of resource in the n-th application as the decision variables, in this embodiment, the ADMM (Alternating Directions Method of Multiplier) method is used to update the decision variables alternately.

In this embodiment, a python thread mechanism is used to update decision variables of respective applications concurrently.

During a t+1-th iteration, following steps S310 to S330 are performed.

At S310, the total allocation yₖ of the k-th type of resource is updated.

An updating formula is:

$${y}_{k}^{t + 1} = arg {min}_{yk} L ( {y}_{k} , {\{ {( {y}_{k}^{n} )}^{T} \}}_{n} , {\{ {u}_{n}^{t} \}}_{n} ) .$$

Because

$$- {\sum }_{n} ( {R}_{k} ( {y}_{k}^{n} ) + h ( {y}_{k}^{n} ) )$$

does not involve yₖ, the above formula can be optimized as follows:

$${y}_{k}^{t + 1} = arg {min}_{{y}_{k}} \frac{n}{2} {\sum }_{n} {‖ {S}_{n} {y}_{k} {y}_{k}^{n} + {u}_{n} ‖}^{2}$$

Gradient of the above formula is solved and set to 0 so as to obtain an updated value of yₖ.

At S320, sub-allocation yₖⁿ of the k-th type of resource corresponding to each application is updated;

$${( {y}_{k}^{n} )}^{t + 1} = arg {min}_{{y}_{k}^{n}} L ( {y}_{k}^{t + 1} , {y}_{k}^{n} , {\{ {( {y}_{k}^{{G}_{{n}^{′}}} )}^{t} \}}_{{n}^{′}} , {\{ {u}_{n}^{t} \}}_{n} )$$

in which n′∈[N]\{n}.

The above formula is expanded to obtain:

$${( {y}_{k}^{n} )}^{t + 1} = arg {min}_{{y}_{k}^{n}} - ( {R}_{k} ( {y}_{k}^{n} ) + h ( {y}_{k}^{n} ) ) + \frac{η}{2} {‖ {S}_{n} {y}_{k} - {y}_{k}^{n} + {u}_{n} ‖}^{2}$$

Because there is nonlinear constraint in the above formula, it is linearized to obtain:

$${( {y}_{k}^{n} )}^{t + 1} \approx {\prod }_{{‖ {y}_{k} ‖}_{( ∞ , 1 )}^{[ N ]} \leq {μ}_{k}} arg {min}_{{y}_{k}^{n}} ( - 〈 ∇ {R}_{k} ( {( {y}_{k}^{n} )}^{t} ) , {y}_{k}^{n} 〉 + \frac{{ρ}_{n}}{2} {‖ {y}_{k}^{n} - {( {y}_{k}^{n} )}^{t} ‖}^{2} + η 〈 {( {y}_{k}^{n} )}^{t} - {S}_{n} {y}_{k}^{t + 1} - {u}_{n}^{t} 〉 )$$

in which:

Π_{∥y}_{ₖ}_{∥}_{_{(∞,1)}}_{^{[N]}}≤μₖ

is a projection of a L₁ sphere with a radius of μₖ;
ρₙ is a constant, which is used to adjust proximity between yₖⁿ and (yₖⁿ)^{t}.

Gradient of the above formula is solved and set to 0 and a projection operation is finally performed, so as to obtain an updated value of yₖⁿ.

At S330, intermediate variables are updated for each application in parallel, that is, dual variables uₙ corresponding to the respective applications are updated in parallel.

$${u}_{n}^{t + 1} = {u}_{n}^{t} + {S}_{n} {y}_{k}^{t + 1} - {( {y}_{k}^{n} )}^{t + 1} ;$$

In this embodiment, the decision variables are iteratively updated based on steps S310 and S330 until a preset iteration completion condition is met, and the obtained iteratively updated decision variables are output as the optimal solution so as to obtain the corresponding resource allocation strategy.

Those skilled in the art can set the iteration completion condition by themselves according to actual needs. In this embodiment, when a number of iterations reaches a preset iteration threshold, the iteration is completed.

In related art, a problem of diversified resource allocation of all of the microservices is not considered in resource allocation, which may results in phenomenon that part of applications are hungry due to unfair resource scheduling. In this embodiment, the group norm is adopted to constrain resource allocation diversification, and finally an optimal solution of the response time under the constraint condition is obtained based on the ADMM algorithm, so that for a complex and dynamic large microservice system, the average response time of the microservice can be minimized on a basis of ensuring certain resource allocation diversification, and resource allocation effect of the large microservice system is effectively improved.

Embodiment 2: a resource allocation system for allocating resources to respective applications based on user request information in a microservice system includes:
a model acquisition module configured to acquire a target optimization model, the target optimization model including a plurality of sub-optimization models in one-to-one correspondence to resources;
   an optimization goal of each of the plurality of sub-optimization models being to minimize a sum of average response time of all of applications on a corresponding resource;
   variables of the sub-optimization model including a decision variable and an environmental variable;
   the decision variable including total allocation and sub-allocation of the corresponding resource, the total allocation referring to allocation of the corresponding resource in the microservice system, and the sub-allocation referring to allocation of the corresponding resource in the respective applications; and
   the environment variable including a set of user requests corresponding to the respective applications and internal communication overhead;
a data acquisition module configured to acquire environmental parameters currently corresponding to the microservice system; and
an optimization module configured to solve respective sub-optimization models in parallel based on the environmental parameters according to Alternating Direction Method of Multipliers to obtain optimal solutions corresponding to respective decision variables and generate a corresponding resource allocation strategy.

Further, the model acquisition module includes a model construction module configured to:
constructing an original calculation function, the original calculation function being configured to calculate average response time of a target application based on the environmental parameters;
constructing a differential constraint condition based on a group norm to obtain a first constraint, the differential constraint condition indicating that for each type of resource, corresponding resources in respective applications are less than or equal to an upper limit threshold of the resource;
taking a matrix vector multiplication form of sub-allocation corresponding to the target application as a second constraint;
constructing a problem of minimizing the sum of average response time of all of the applications based on the original calculation function, the first constraint and the second constraint to obtain a target optimization problem; and
dividing the target optimization problem into sub-problems in one-to-one correspondence to the resources, and taking an augmented Lagrangian function corresponding to respective sub-problems as a corresponding sub-optimization model.

Embodiment 3: a computer-readable storage medium having computer program stored thereon which, when executed by a processor, implements steps of the resource allocation method described in Embodiment 1.

Embodiment 4: an electronic device includes a memory, a processor and a computer program stored on the memory and operable on the processor, and the processor implements the resource allocation method described in Embodiment 1 when executing the computer program.

As for device embodiments, they are basically similar to method embodiments and description thereof is relatively simple, and reference can be made to the description of the method embodiment for relevant aspects.

All the embodiments in this specification are described in a progressive way, and each embodiment focuses on differences from other embodiments. The same and similar parts among the embodiments can be referred to each other.

It should be understood by those skilled in the art that embodiments of the present disclosure may be provided as a method, a device, or a computer program product. Therefore, the present disclosure may be implemented in an entire hardware embodiment, an entire software embodiment, or an embodiment combining the software and the hardware. Furthermore, the present disclosure may be implemented in the form of a computer program product embodied on one or more computer usable storage media (including but not limited to disk memory, CD-ROM, optical memory, etc.) having computer usable program code contained therein.

The present disclosure is described with reference to a flowchart and/or block diagram of a method, a terminal device (system), and a computer program product according to the present disclosure. It should be understood that each flow and/or block in the flowchart and/or block diagram, or a combination of flows and/or blocks in the flowchart and/or block diagram can be implemented with computer program instructions. These computer program instructions can be provided to a processor of a general purpose computer, a special purpose computer, an embedded processor or other programmable data processing terminal device to produce a machine, so that the instructions executed by the processor of the computer or other programmable data processing terminal device produce means for implementing the functions specified in one or more flows in the flowchart and/or in one or more blocks in block diagram.

These computer program instructions can also be stored in a computer-readable memory that can guide a computer or other programmable data processing terminal device to work in a specific way, so that the instructions stored in the computer-readable memory produce an article of manufacture including instruction means that implements the functions specified in one or more flows in the flowchart and/or in one or more blocks in the block diagram.

These computer program instructions can also be loaded on a computer or other programmable data processing terminal device, so that a series of operation steps are executed on the computer or other programmable terminal device to produce computer-implemented processing, so that the instructions executed on the computer or other programmable terminal device provide steps for implementing functions specified in one or more flows in the flowchart and/or in one or more blocks in block diagrams.

It should be noted that:

Reference to “one embodiment” or “an embodiment” in the specification means that a specific feature, structure or characteristic described in connection with embodiments is included in at least one embodiment of the present disclosure. Therefore, the phrases “one embodiment” or “an embodiment” appearing in various places throughout the specification do not necessarily refer to the same embodiment.

Although the preferred embodiments of the present disclosure have been described, additional changes and modifications can be made to these embodiments by those skilled in the art once basic inventive concepts are known. Therefore, the appended claims are intended to be interpreted as including the preferred embodiments and all changes and modifications falling within the scope of the present disclosure.

In addition, it should be noted that the specific embodiments described in this specification may have different shapes, names or the like of parts and components. Equivalent or simple changes made in accordance with the configurations, features and principles described in the inventive concept are included in the scope of protection of the inventive disclosure. Various modifications, supplements or similar replacements can be made to the described specific embodiments by those skilled in the art to which the present disclosure pertains, which fall within the protection scope of the present disclosure without departing from the structure of the present disclosure or beyond the scope defined by the claims.

1. A resource allocation method for allocating resources to respective applications by a processor based on user request information in a microservice system stored on a computer-readable storage medium or a memory, the resource allocation method comprising:
acquiring a target optimization model by the microservice system, the target optimization model comprising a plurality of sub-optimization models in one-to-one correspondence to resources;
an optimization goal of each of the plurality of sub-optimization models being to minimize a sum of average response time of all of applications on a corresponding resource;
variables of the sub-optimization model comprising a decision variable and an environmental variable;
the decision variable comprising total allocation and sub-allocation of the corresponding resource, the total allocation referring to allocation of the corresponding resource in the microservice system, and the sub-allocation referring to allocation of the corresponding resource in the respective applications; and
the environment variable comprising a set of user requests corresponding to the respective applications and internal communication overhead;
acquiring environmental parameters currently corresponding to the microservice system;
solving respective sub-optimization models in parallel by the processor based on the environmental parameters, according to Alternating Direction Method of Multiplier, to obtain optimal solutions corresponding to respective decision variables and generate a corresponding resource allocation strategy.

2. The resource allocation method according to claim 1, wherein the target optimization model is constructed by constructing an original calculation function, the original calculation function being configured to calculate average response time of a target application based on the environmental parameters;
constructing a diversified constraint condition based on a group norm to obtain a first constraint, the diversified constraint condition indicating that for each type of resource, corresponding resources in respective applications are less than or equal to an upper limit threshold of the resource;
taking a matrix vector multiplication form of sub-allocation corresponding to the target application as a second constraint;
constructing a problem of minimizing the sum of average response time of all of the applications based on the original calculation function, the first constraint and the second constraint to obtain a target optimization problem; and
dividing the target optimization problem into sub-problems in one-to-one correspondence to the resources, and taking an augmented Lagrangian function corresponding to respective sub-problems as a corresponding sub-optimization model.

3. The resource allocation method according to claim 2, wherein the original calculation function is:
$$MRT ( {λ}_{n} , {Γ}_{n} , {y}^{{G}_{n}} ) = \frac{{L}_{n}}{{λ}_{n}} + \frac{1}{{f}_{n} ( {Γ}_{n} , {y}^{{G}_{n}} ) - {O}_{n} ( {Γ}_{n} , )}$$
wherein:
MRT (λₙ, Γₙ, y^{G}^{ₙ}) is average response time corresponding to a n-th application;
$$\frac{{L}_{n}}{{λ}_{n}}$$
is average waiting time or a queue;
$$\frac{1}{{f}_{n} ( {Γ}_{n} , {y}^{{G}_{n}} ) - {O}_{n} ( {Γ}_{n} , )}$$
is average service time;
λₙ is an average rate at which an user request arrives at the n-th application;
Lₙ is an average number of user requests in a queue corresponding to the n-th application;
Γₙ is a set of user requests corresponding to the n-th application;
y^{G}^{ₙ} represents sub-allocation of respective resources in the n-th application;
fₙ(Γₙ, y^{G}^{ₙ}) represents an average processing speed of the n-th application for a set Γₙ of arrived user requests and a resource with given y^{G}^{ₙ}; and
Oₙ(Γₙ, [symbol] ) represents internal communication overhead of the n-th application.

4. The resource allocation method according to claim 3, wherein
the target optimization problem is as follows:
$$\begin{matrix}: {min}_{y} {\sum }_{n ∈ [ N ]} MRT ( {λ}_{n} , {Γ}_{n} , {y}^{{G}_{n}} ) \\ s . t . \{ \begin{matrix}‖ {y}_{k} {‖}_{( ∞ , 1 )}^{[ N ]} \leq {μ}_{k} , ∀ k \\ {y}_{k}^{n} = {S}_{n} {y}_{k} , ∀ k , n\end{matrix} \\ {{{{‖ {y}_{k} ‖}_{( ∞ , 1 )}^{[ N ]} := ‖ [ {‖ {y}_{k}^{{G}_{1}} ‖}_{1} , … , ‖ {y}_{k}^{{G}_{n}} ‖}_{1} ]}^{T} ‖}_{∞} \\ {[ {S}_{n} ]}_{mm} = \{ \begin{matrix}1 , & m ∈ {v}_{n} \\ 0 , & otherwise\end{matrix}\end{matrix}$$
wherein:
yₖ is total distribution of a k-th type of resource;
yₖ^{G}^{_{N}} is sub-allocation of a k-th type of resource in the n-th application, and yₖⁿ is short, for yₖ^{G}^{_{N}};
Sₙ is a diagonal matrix;
μₖ is an upper threshold corresponding to the k-th type of resource; [symbol]
is a set of microservices in the n-th application; and
m is a m-th microservice in the n-th application.

5. The resource allocation method according to claim 4, wherein
a sub-problem corresponding to the k-th type of resource is as follows:
$$\begin{matrix}( k ) : {min}_{{y}_{k}} - {\sum }_{n ∈ [ N ]} ( {R}_{k} ( {y}_{k}^{n} ) + h ( {y}_{k}^{n} ) ) \\ s . t . {y}_{k}^{n} = {S}_{n} {y}_{k} , ∀ n . \\ {R}_{k} ( {y}_{k}^{n} ) := \frac{{α}_{k}}{\vert {Γ}_{n} \vert} {\sum }_{r ∈ {Γ}_{n}} {f}_{nk} ( {y}_{k}^{n} ) - \frac{1}{K {α}_{k}} {O}_{n} ( {Γ}_{n} , ) \\ h ( {y}_{k}^{n} ) = 𝕝 \{ {‖ {y}_{k}^{n} ‖}_{1} \leq {μ}_{k} \} , ∀ k , n\end{matrix} ,$$
wherein:
a fₙₖ function is a processing speed of the n-th application for a user request r after being allocated with the k-th type of resource;
αₖ is a contribution weight of the processing speed corresponding to the k-th type of resource to a final service rate; and
K is a total number of resource types.

6. The resource allocation method according to claim 1, wherein
the sub-optimization model is an augmented Lagrangian function in a dual form;
the sub-optimization model corresponding to the k-th type of resource is expressed as follows:
$$\begin{matrix}L ( {y}_{k} , {\{ {y}_{k}^{n} \}}_{n} , {\{ {u}_{n} \}}_{n} ) = - {\sum }_{n} ( {R}_{k} ( {y}_{k}^{n} ) ) + \frac{η}{2} {\sum }_{n} {‖ {S}_{n} {y}_{k} - {y}_{k}^{n} + {u}_{n} ‖}^{2} \\ {R}_{k} ( {y}_{k}^{n} ) := \frac{{α}_{k}}{\vert {Γ}_{n} \vert} {\sum }_{r ∈ {Γ}_{n}} {f}_{nk} ( {y}_{k}^{n} ) - \frac{1}{K {α}_{k}} {O}_{n} ( {Γ}_{n} , ) . \\ h ( {y}_{k}^{n} ) = 𝕝 \{ {‖ {y}_{k}^{n} ‖}_{1} \leq {μ}_{k} \} , ∀ k , n \\ {[ {S}_{n} ]}_{mm} = \{ \begin{matrix}1 , & m ∈ {v}_{n} \\ 0 , & otherwise\end{matrix}\end{matrix}$$
wherein:
yₖ is total distribution of a k-th type of resource;
yₖⁿ is sub-allocation of a k-th type of resource in the n-th application;
{uₙ}ₙ is a dual variable; and
η is a penalty coefficient;
αₖ is a contribution weight of the processing speed corresponding to the k-th type of resource to a final service rate;
Γₙ is a set of user requests corresponding to the n-th application;
a fₙₖ function is a processing speed of the n-th application for a user request r after being allocated with the k-th type of resource;
K is a total number of resource types;
Oₙ(Γₙ, [symbol] ) represents internal communication overhead of the n-th application;
Sₙ is a diagonal matrix;
μₖ is an upper threshold corresponding to the k-th type of resource; [symbol]
is a set of microservices in the n-th application; and
m is a m-th microservice in the n-th application.

7. A resource allocation system for allocating resources to respective applications by a processor based on user request information in a microservice system stored on a computer-readable storage medium or a memory, the resource allocation system comprising:
a model acquisition module configured to acquire a target optimization model, the target optimization model including a plurality of sub-optimization models in one-to-one correspondence to resources;
an optimization goal of each of the plurality of sub-optimization models being to minimize a sum of average response time of all of applications on a corresponding resource;
variables of the sub-optimization model comprising a decision variable and an environmental variable;
the decision variable comprising total allocation and sub-allocation of the corresponding resource, the total allocation referring to allocation of the corresponding resource in the microservice system, and the sub-allocation referring to allocation of the corresponding resource in the respective applications; and
the environment variable comprising a set of user requests corresponding to the respective applications and internal communication overhead;
a data acquisition module configured to acquire environmental parameters currently corresponding to the microservice system; and
an optimization module configured to solve respective sub-optimization models in parallel based on the environmental parameters according to Alternating Direction Method of Multiplier to obtain optimal solutions corresponding to respective decision variables and generate a corresponding resource allocation strategy.

8. The resource allocation system according to claim 7, wherein the model acquisition module comprises a model construction module configured to:
construct an original calculation function, the original calculation function being configured to calculate average response time of a target application based on the environmental parameters;
construct a diversified constraint condition based on a group norm to obtain a first constraint, the diversified constraint condition indicating that for each type of resource, corresponding resources in respective applications are less than or equal to an upper limit threshold of the resource;
take a matrix vector multiplication form of sub-allocation corresponding to the target application as a second constraint;
construct a problem of minimizing the sum of average response time of all of the applications based on the original calculation function, the first constraint and the second constraint to obtain a target optimization problem; and
divide the target optimization problem into sub-problems in one-to-one correspondence to the resources, and take an augmented Lagrangian function corresponding to respective sub-problems as a corresponding sub-optimization model.

9. A computer-readable storage medium having a computer program stored thereon, wherein the computer program, when executed by a processor, implements steps of the resource allocation method according to claim 1.

10. An electronic device, comprising a memory, a processor and a computer program stored on the memory and operable on the processor, the processor implementing steps of the resource allocation method according to claim 1.
